(19) United States
(12) Patent Application Publication
(10) Pub. No.: US 2016/0344304 A1
(43) Pub. Date: Nov. 24, 2016

(54) SEMICONDUCTOR POWER CONVERSION APPARATUS AND OUTPUT CURRENT CONTROL METHOD

(71) Applicant: MITSUBISHI ELECTRIC CORPORATION, Tokyo (JP)

(72) Inventor: Masafumi ICHIHARA, Tokyo (JP)

(73) Assignee: Mitsubishi Electric Corporation, Tokyo (JP)

(21) Appl. No.: 14/397,614

(22) PCT Filed: Jan. 21, 2014
(86) PCT No.: PCT/JP2014/051109

§ 371 Date: Oct. 28, 2014

(51) Int. Cl. H02M 7/5395; H02M 1/12; H02M 1/08

(52) U.S. Cl. CPC H02M 7/5395; H02M 1/08; H02M 1/126; H02M 2001/0009

(57) ABSTRACT

Provided is a semiconductor power conversion apparatus that includes: a semiconductor power converter that performs power conversion by using switching elements and supplies power to a load; a converter-voltage command calculation unit that outputs a voltage command value Vref that controls the semiconductor power converter; a voltage control unit that superimposes a second voltage command value on the voltage command value Vref to generate a voltage command value Vref2; a PWM-signal generation unit that generates a gate signal for controlling driving of the switching elements based on the voltage command value Vref2 and outputs the gate signal; and a bypass unit that is connected to the semiconductor power converter in parallel with the load and branches a current of a frequency of the second voltage command value off from an output current Iout that is output from the semiconductor power converter to the load.

### FIELD

The present invention relates to a semiconductor power conversion apparatus and an output current control method with a thermal cycle capability improved.

### BACKGROUND

In the prior art, a semiconductor power conversion apparatus changes an output voltage when needed during an operation, for its original purpose of a converter. So, the output current amplitude also changes according to the change of the output voltage. Because the temperature of semiconductor devices that constitute the semiconductor power conversion apparatus also change due to the change of an output current, if the current changes largely and frequently, the semiconductor devices degrade due to a thermal cycle (power cycle/heat cycle).

As a method of suppressing the thermal cycle, for example, in Patent Literature 1 listed below, a technique is disclosed in which increasing a gate resistance of a semiconductor device and lowering a gate voltage thereof raise a loss of the semiconductor device and the temperature thereof. Patent Literature 2 listed below discloses a technique in which heightening a switching frequency increases a loss of a semiconductor device. Further, Patent Literature 3 listed below discloses a technique in which stopping external cooling operation raises the temperature of a semiconductor device.

### CITATION LIST

### Patent Literatures

Patent Literature 1: Japanese Patent Application Laid-open No. 2003-7934

Patent Literature 2: Japanese Patent Application Laid-open No. 2002-125362

Patent Literature 3: Japanese Patent Application Laid-open No. 2001-298964

### SUMMARY

### Technical Problem

However, the prior arts described above are able to increase the losses in a restricted range. When a semiconductor power conversion apparatus outputs an output current value that is fairly small, a loss for stabilizing the temperature does not generate sufficiently enough to operate effectively.

The present invention has been made to solve the problems above, and an object of the present invention is to provide a semiconductor power conversion apparatus and an output current control method in which an output current value, from the semiconductor power conversion apparatus to a load, can be controlled to fall in a specific value.

### Solution to Problem

To solve the problems and achieve the object above, the present invention is an semiconductor power conversion apparatus that includes: a power converter that performs power conversion by using a switching element and supplies power to a load; a converter-voltage command calculation unit that outputs a first voltage command value that controls the power converter; a voltage control unit that superimposes a second voltage command value on the first voltage command value to generate a third voltage command value; a PWM-signal generation unit that generates a gate signal for controlling driving of the switching element based on the third voltage command value and outputs the gate signal to the power converter; and a bypass unit that is connected to the power converter in parallel with the load and branches a current with a frequency of the second voltage command value off from an output current that is output from the power converter to the load.

### Advantageous Effects of Invention

The semiconductor power conversion apparatus and the output current control method according to the present invention can effectively control an output current value to a load and an output current value to a bypass unit from the semiconductor power conversion apparatus separately to a specific value.

### BRIEF DESCRIPTION OF DRAWINGS

FIG. 1 is a diagram illustrating a configuration example of a semiconductor power conversion apparatus according to a first embodiment.

FIG. 2 is a flowchart illustrating an output-current control process in the semiconductor power conversion apparatus.

FIG. 3 is a diagram illustrating a configuration example of a voltage control unit according to the first embodiment.

FIG. 4 is a diagram illustrating impedance characteristics of a bypass unit.

FIG. 5 is a diagram illustrating a configuration example of the bypass unit.

FIG. 6 is a diagram illustrating how an output current Iout output from the semiconductor power conversion apparatus is, and how a current flowing to a load and a bypass unit is in the first embodiment.

FIG. 7 is a diagram illustrating how an output current Iout output from a semiconductor power conversion apparatus is, and how a current flowing to a load and a bypass unit is in a second embodiment.

FIG. 8 is a diagram illustrating a configuration example of a voltage control unit according to a third embodiment.

### DESCRIPTION OF EMBODIMENTS

Exemplary embodiments of a semiconductor power conversion apparatus and an output current control method according to the present invention will be described below in detail with reference to the accompanying drawings. The present invention is not limited to these embodiments.

### First Embodiment

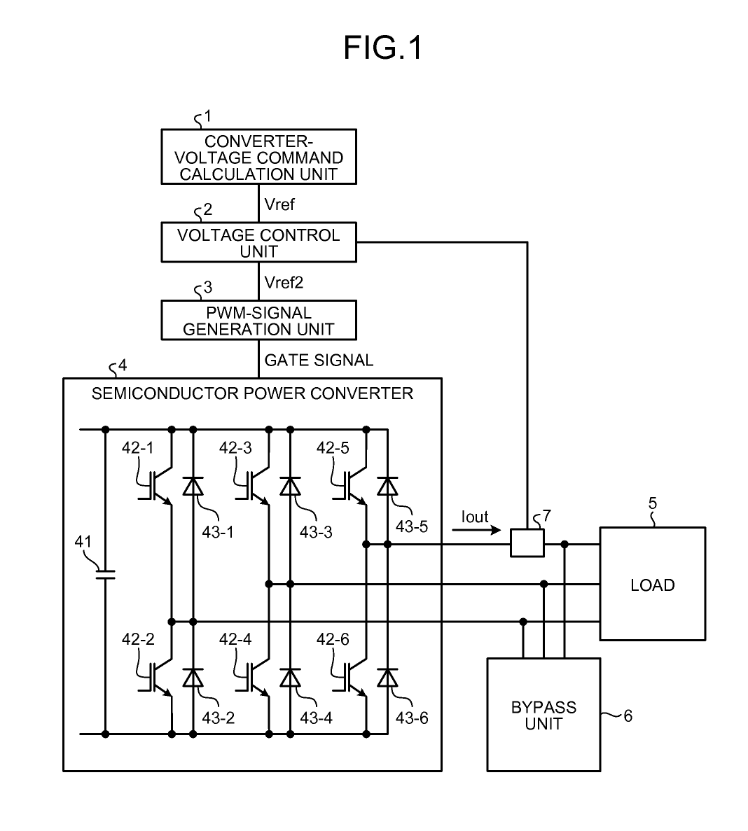

FIG. 1 is a diagram illustrating a configuration example of a semiconductor power conversion apparatus according to the present embodiment. The semiconductor power conversion apparatus includes a converter-voltage command calculation unit 1, a voltage control unit 2, a PWM (Pulse Width Modulation)-signal generation unit 3, a semiconductor power converter 4, a load 5, a bypass unit 6, and a current detection unit 7.

The converter-voltage command calculation unit 1 calculates a voltage command value Vref (a first voltage command value) that controls operations of the semiconductor power converter 4 to which the load 5 is connected, and outputs the voltage command value Vref to the voltage control unit 2. This configuration is identical to those of conventional techniques.

The voltage control unit 2 operates a control of superimposing a voltage in a certain frequency band (a second voltage command value) on the voltage command value Vref input from the converter-voltage command calculation unit 1 in order to control an output current Iout from the semiconductor power converter 4 detected by the current detection unit 7 to a specific value. The voltage control unit 2 superimposes a voltage in a certain frequency band on the voltage command value Vref to generate a voltage command value Vref2 (a third voltage command value), and outputs the voltage command value Vref2 to the PWM-signal generation unit 3.

The PWM-signal generation unit 3 generates a gate signal to control the driving of a switching element provided in the semiconductor power converter 4 in accordance with on the voltage command value Vref input from the voltage control unit 2, and outputs the gate signal to the semiconductor power converter 4. This configuration is identical to those of conventional techniques.

The semiconductor power converter 4 includes a capacitor 41, switching elements 42-1 to 42-6, and diodes 43-1 to 43-6. The semiconductor power converter 4 drives the switching elements 42-1 to 42-6 according to the gate signal from the PWM-signal generation unit 3 to convert DC power supplied from a DC power source (not shown) to AC power, and outputs AC power to the load 5. This configuration is identical to those of conventional techniques.

The load 5 is operated upon a supply of AC power output from the semiconductor power converter 4. The load 5 includes, for example a motor and the like, which is not limited thereto.

The bypass unit 6 is connected to the semiconductor power converter 4 in parallel with the load 5, and branches a current of a superimposition frequency (a frequency of a second voltage command value) of a superimposed component, which is a voltage superimposed by the voltage control unit 2, off from the output current Iout output from the semiconductor power converter 4 to the load 5. The bypass unit 6 can include, for example, an LC resonant circuit.

The current detection unit 7 detects a current value of the output current Iout output from the semiconductor power converter 4 to the load 5, and outputs the detected output current value Iout to the voltage control unit 2. Note that the value Iout may be used for either the output current or the output current value, which is similarly applied to the following descriptions.

Next, described are the operations of the semiconductor power conversion apparatus to control the output current value Iout output from the semiconductor power converter 4 to the load 5 to a specific value.

First, described is the reason why the output current value Iout, output from the semiconductor power converter 4 to the load 5, needs to be controlled to fall in a specific value. If a case is considered in which the size of the voltage command value Vref is not controlled by the voltage control unit 2 in the semiconductor power conversion apparatus illustrated in FIG. 1, the operation thereof is the same as that of a common semiconductor power conversion apparatus. In this case, the voltage command value Vref calculated by the converter-voltage command calculation unit 1 fluctuates because power required in the load 5 is output from the semiconductor power converter 4. The PWM-signal generation unit 3 generates a gate signal based on the voltage command value Vref; and the semiconductor power converter 4 drives the switching elements 42-1 to 42-6 according to the gate signal to generate AC power, and outputs AC power to the load 5. The output current value Iout output from the semiconductor power converter 4 varies according to the size of the voltage command value Vref. The varying of the output current value Iout means the changing of generation losses in the semiconductor power converter 4.

In a case where the output current value Iout output from the semiconductor power converter 4 stays constant, the losses in the semiconductor power converter 4 stays constant, and the degradation of components due to thermal cycles can be suppressed. When the output current Iout is allowed to be small, the output current value Iout output from the semiconductor power converter 4 can be kept constant by superimposing a current which is needless to the load 5. However, if the semiconductor power converter 4 outputs even a current needless to the load 5 and flows all the current to the load 5, it affects to the operation of the load 5 and causes a failure.

Therefore, in the present embodiment, the voltage control unit 2 operates a control to superimpose the amount of the superimposition component which is a voltage to be superimposed on the voltage command value Vref from the converter-voltage command calculation unit 1, so that the output current value Iout output from the semiconductor power converter 4 falls in a specific value. The bypass unit 6 branches a current not required in the load 5, which is added and corresponds to the superimposition component superimposed on the voltage command value Vref by the control of the voltage control unit 2, off from the output current Iout output from the semiconductor power converter 4 toward into the bypass unit 6 itself. Thus, the semiconductor power conversion apparatus can control that the output current value Iout to be output from the semiconductor power converter 4 falls in the specific value without affecting the load 5 at all.

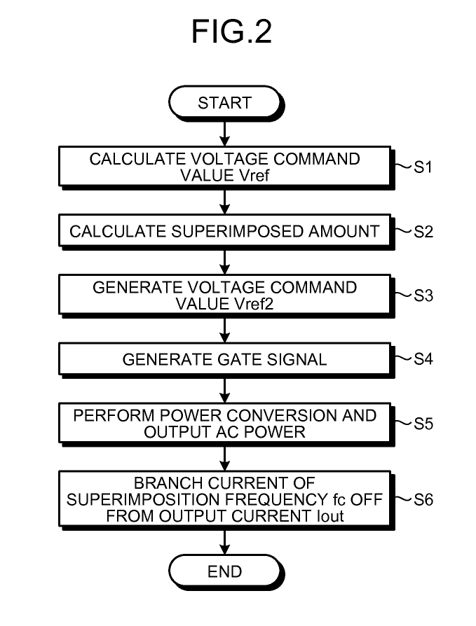

Operations of the semiconductor power conversion apparatus are specifically explained in reference to a flowchart. FIG. 2 is a flowchart illustrating an output-current control process in the semiconductor power conversion apparatus.

First, the converter-voltage command calculation unit 1 calculates and obtains the voltage command value Vref for the load 5 based on an original operation of the semiconductor power converter 4, and outputs the obtained voltage command value Vref to the voltage control unit 2 (Step S1).

The voltage control unit 2 receives the voltage command value Vref from the converter-voltage command calculation unit 1 and calculates the superimposing amount of the superimposition component, which is the voltage to be superimposed on the voltage command value Vref, in accordance with the output current value Iout from the semiconductor power converter 4 obtained by way of the current detection unit 7 (Step S2).

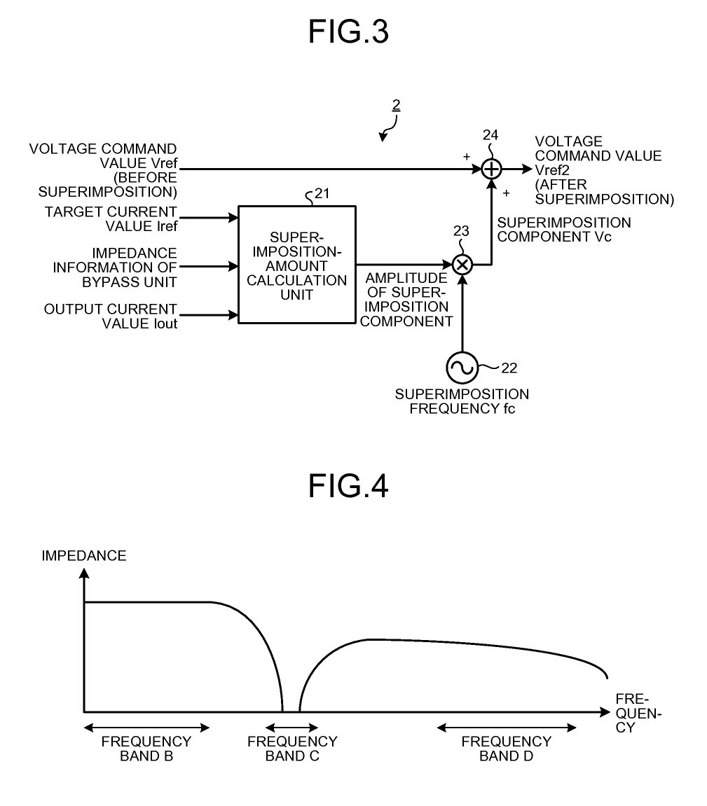

A calculating method of the superimposing amount in the voltage control unit 2 is explained in detail. FIG. 3 is a diagram illustrating a configuration example of a voltage control unit according to the present embodiment. The voltage control unit 2 includes a superimposition-amount calculation unit 21, a superimposition-frequency signal transmitter 22, a multiplier 23, and an adder 24.

The superimposition-amount calculation unit 21 obtains a target current value Iref which is a target value for setting the output current value Iout from the semiconductor power converter 4 to a specific value; the output current value Iout from the semiconductor power converter 4 detected by the current detection unit 7; and impedance information when the bypass unit 6 includes the LC resonant circuit, and calculates the superimposing amount by using these pieces of information.

The target current value Iref is a fixed value determined according to the load 5 to be connected, an operation pattern of the semiconductor power converter 4, and the like. A user or the like inputs the target current value Iref, which has been selected from a plurality of candidates or set arbitrarily in advance, to the superimposition-amount calculation unit 21. The target current value Iref may be designed changeable even during the operation of the semiconductor power conversion apparatus. The user or the like inputs the impedance information in advance to the superimposition-amount calculation unit 21 based on the configuration of the LC resonant circuit of the bypass unit 6.

For example, when the size of the target current value Iref is “10” and the size of the output current value Iout is “8”, the superimposition-amount calculation unit 21 generates and outputs an amplitude of the superimposition component, which is voltage information indicating that the superimposing amount of “2” is superimposed on the output current value Iout, by using the impedance information of the bypass unit 6, so that the current of the size of the difference “10−8=2” is superimposed on the output current Iout from the semiconductor power converter 4.

The multiplier 23 multiplies a signal of a superimposition frequency fc output from the superimposition-frequency signal transmitter 22 with the amplitude of the superimposition component output from the superimposition-amount calculation unit 21, and generates and outputs a superimposition component Vc, which is a voltage to be superimposed on the voltage command value Vref so as to control the output current value Iout. The adder 24 superimposes the superimposition component Vc from the multiplier 23 on the voltage command value Vref from the converter-voltage command calculation unit 1, and generates and outputs the voltage command value Vref2 indicating that the superimposing amount of “2” is superimposed on the output current Iout (step S3).

In the above explanations, the superimposition-amount calculation unit 21 obtains the amplitude of the superimposition component by proportional control, which is only one example and other methods can be applied.

The PWM-signal generation unit 3 generates a gate signal in accordance with the voltage command value Vref2 input from the voltage control unit 2 (Step S4). The PWM-signal generation unit 3 outputs the generated gate signal to the semiconductor power converter 4.

The semiconductor power converter 4 operates controls to drive the respective switching elements 42-1 to 42-6 according to the gate signal input from the PWM-signal generation unit 3, converts DC power to AC power, and outputs AC power to the load 5 (Step S5). The output current Iout of the AC power output at this time is made by superimposing a current of the superimposition frequency fc by the superimposition component Vc (which is a current of a frequency component in a second frequency band) on a current originally required in the load 5 in accordance with the voltage command value Vref (a current of a frequency component in a first frequency band), and is controlled so as to fall in a specific value (the target current value Iref). That is, when the current of the frequency component in the first frequency band which is the current based on the first voltage command value is to decrease, the semiconductor power converter 4 increases the current of the frequency component in the second frequency band which is the current based on the second voltage command value, and outputs the current; and when the current of the frequency component in the first frequency band is to increase, the semiconductor power converter 4 decreases the frequency component in the second frequency band, and outputs the current.

The bypass unit 6 then branches the current of the superimposition frequency fc, which is a frequency component of the superimposition component Vc, off from the output current Iout output from the semiconductor power converter 4 to the load 5 (Step S6). FIG. 4 is a diagram illustrating impedance characteristics of a bypass unit. A frequency is plotted on an x axis, and impedance is plotted on a y axis. In FIG. 4, a frequency band B is related to a basic operation in the semiconductor power converter 4, and is generally a commercial frequency band of 400 hertz at the highest and normally from 50 to 60 hertz. A frequency band D indicates a range of a carrier frequency caused by switching of the switching elements 42-1 to 42-6 provided in the semiconductor power converter 4, and is generally 2 kilohertz or higher. The impedance of the frequency bands B and D are sufficiently high, so that the components of the frequency bands B and D of the output current Iout that is output from the semiconductor power converter 4 flows to the load 5, without flowing into the bypass unit 6 (which means not being branched off). On the other hand, the impedance corresponding to a frequency band C is low. That is, the component of the frequency band C of the output current Iout output from the semiconductor power converter 4 flows (branched off) into the bypass unit 6. The frequency band C is set larger than the frequency band B and smaller than the frequency band D, for example, to be around 1 kilohertz, which is a frequency equivalent to the LC resonant frequency in a case where the bypass unit 6 includes the LC resonant circuit.

In the present embodiment, the superimposition frequency fc of the superimposition component Vc which is to be superimposed on the voltage command value Vref by the voltage control unit 2 and the frequency band C illustrated in FIG. 4 are set same frequency band. Accordingly, in the semiconductor power conversion apparatus, even if the voltage control unit 2 superimposes the superimposition component Vc on the voltage command value Vref originally required by the semiconductor power converter 4, the current of the superimposition frequency fc (the frequency band C) which is the frequency component of the superimposition component Vc can flow (can be branched off) to the bypass unit 6, off from the output current Iout including the superimposition component output from the semiconductor power converter 4. In the semiconductor power conversion apparatus, the current other than the current of the superimposition frequency fc (the frequency band C) which is the frequency component of the superimposition component Vc, that is, the current of the frequency component of the voltage command value Vref originally required by the semiconductor power converter 4 can be made flow into the load 5.

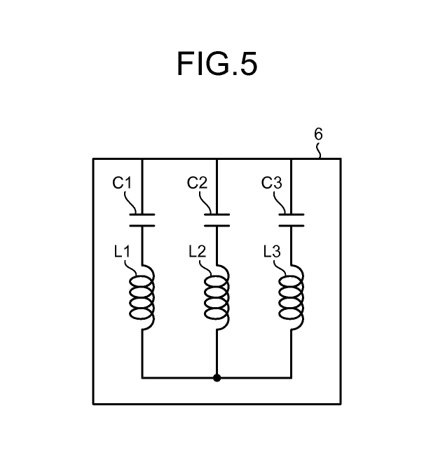

FIG. 5 is a diagram illustrating a configuration example of the bypass unit. The bypass unit 6 includes capacitors C1, C2, and C3, and inductors L1, L2, and L3. One capacitor and one inductor are included in one LC resonant circuit, and each LC resonant circuit is connected to any one of connecting wires from the semiconductor power converter 4 to the load 5 in FIG. 1. The resonant frequency of the LC resonant circuit is set to be the superimposition frequency fc by setting constants of the respective capacitors and the respective inductors so that the bypass unit 6 can be easily formed.

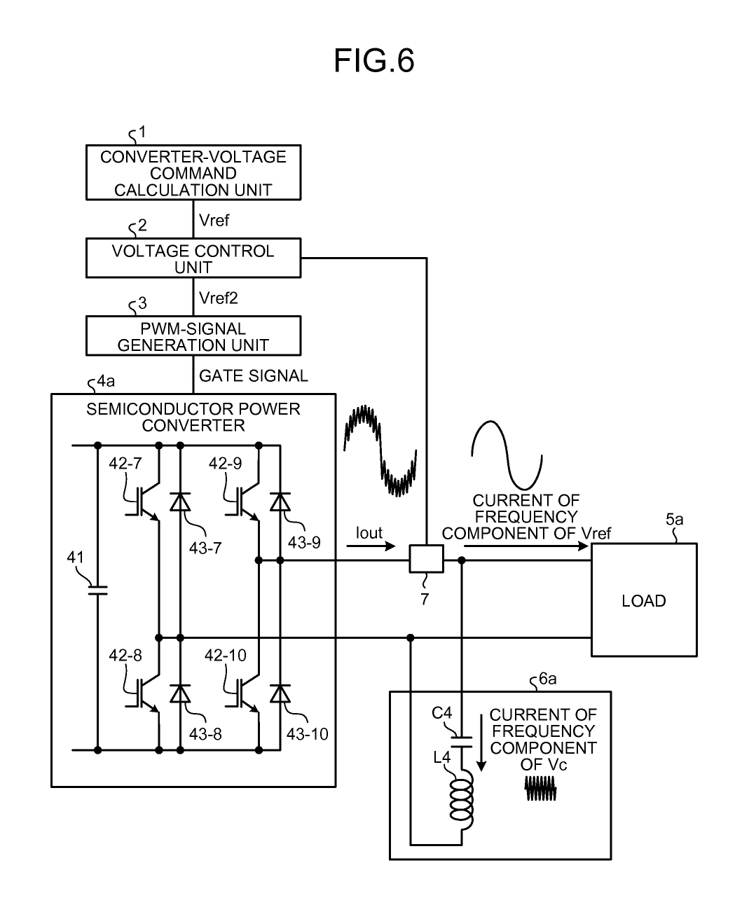

FIG. 6 is a diagram illustrating how the output current Iout output from the semiconductor power conversion apparatus is, and how a current flowing to a load and a bypass unit is in the present embodiment. To simplify the explanation, it is simulated that a semiconductor power converter 4a is a single-phase converter, and a load 5a and a bypass unit 6a correspond to a signal phase. Note that in the case of a three-phase converter as illustrated in FIG. 1, the relation of a current flowing to respective phases is identical to that of FIG. 6. The semiconductor power converter 4a includes the capacitor 41, switching elements 42-7 to 42-10, and diodes 43-7 to 43-10.

In FIG. 6, the output current Iout output from the semiconductor power converter 4a corresponds to the voltage command value Vref2 in which the superimposition component Vc is superimposed on the original voltage command value Vref; and a waveform of a sine-wave corresponding to the voltage command value Vref is superimposed thereon with a waveform of the harmonic superimposition frequency fc of the superimposition component Vc. Connected to the semiconductor power converter 4a in parallel with the load 5a is the bypass unit 6a having the impedance characteristic as illustrated in FIG. 4 that includes the LC resonant circuit including a capacitor C4 and an inductor L4 and has the same resonant frequency (fc) as that of the superimposition frequency fc. The bypass unit 6a branches the current of the harmonic superimposition frequency fc, which is the frequency component of the superimposition component Vc, off from the output current Iout output from the semiconductor power converter 4a. As a result, as illustrated in FIG. 6, the current having the frequency component of the original voltage command value Vref flows to the load 5a, of which value is the same as the one before the voltage command value Vref2 being superimposed of the superimposition component Vc.

In this manner, in the semiconductor power conversion apparatus, when the output current Iout output from the semiconductor power converter 4 (or 4a) is to be set to a specific value, the current corresponding to the superimposition component Vc superimposed by the voltage control unit 2 can be branched off by the bypass unit 6, regardless of the superimposed amount. Accordingly, the current needlessly flowing to the load 5 (or 5a) can be avoided.

As explained above, according to the present embodiment, the voltage control unit 2 executes control to superimpose the voltage of the superimposition component Vc on the original voltage command value Vref derived from the control operation by the semiconductor power converter 4 based on the output voltage value Iout from the semiconductor power converter 4. Accordingly, the output current Iout from the semiconductor power converter 4 can be controlled to fall in a specific value, that is, within certain amplitude. Furthermore, the bypass unit 6 branches the current of the superimposition frequency fc, which is the frequency component of the superimposition component Vc superimposed by the voltage control unit 2, off from the output current output from the semiconductor power converter 4. Accordingly, the current originally required for the control can flow to the load 5 derived from the voltage command value Vref. Accordingly, the output current value Iout from the semiconductor power converter 4 can be kept constant; thus, current loads of semiconductor devices included in the semiconductor power converter 4 can be made constant; and, as a result, a generation loss becomes constant and the temperature becomes constant. Consequently, degradation of the component caused by thermal cycles can be suppressed.

In the present embodiment, the superimposing amount of the superimposition component Vc is controlled such that the output current Iout from the semiconductor power converter 4 becomes constant, however the operation method is not limited thereto. For example, a feedback control method using a constant current effective value, a constant current mean value, or the like or a method combining these methods can be applied, addressing factors of the generation loss in the semiconductor power converter 4.

Generally, when a wide band-gap semiconductor made of SiC or GaN is used for the switching elements 42-1 to 42-6 of the semiconductor power converter 4, because an upper temperature limit of a wide band-gap semiconductor is high, the range of the thermal cycle needs to be widely kept for utilizing the characteristics of the upper temperature limit. However, in the present embodiment, the problem of thermal cycle degradation can be resolved while utilizing the characteristics of heat resistance of the wide band-gap semiconductor.

Further, the bypass unit 6 can be configured to be installed in the semiconductor power conversion apparatus in advance, or to be connected or replaced afterwards along with the load 5. For example, in a case where the superimposition frequency fc of the superimposition component Vc is variable, by connecting the bypass unit 6 that matches the superimposition frequency fc of the superimposition component Vc after the LC resonant frequency of the LC resonant circuit has changed, different superimposition frequencies fc are available for uses.

Further, described above is a configuration where the converter-voltage command calculation unit 1, the voltage control unit 2, and the PWM-signal generation unit 3 are separate units; however the functions of the three units can be configured to integrate into a gate-signal generation unit so that the gate-signal generation unit calculates the voltage command value Vref and the superimposing amount, and generates the voltage command value Vref2 and the gate signal.

### Second Embodiment

In the first embodiment, the capacitor and the inductor are provided inside the bypass unit 6 and are included in the LC resonant circuit. However, in some configuration of the apparatus, an inductance component (an inductor) may be connected in advance to an output of the semiconductor power converter 4 for suppressing a surge voltage or the like at the end of the load 5. In such a case, newly adding a capacitor can constitute an LC resonant circuit along with an inductance component (an inductor) connected in advance thereto.

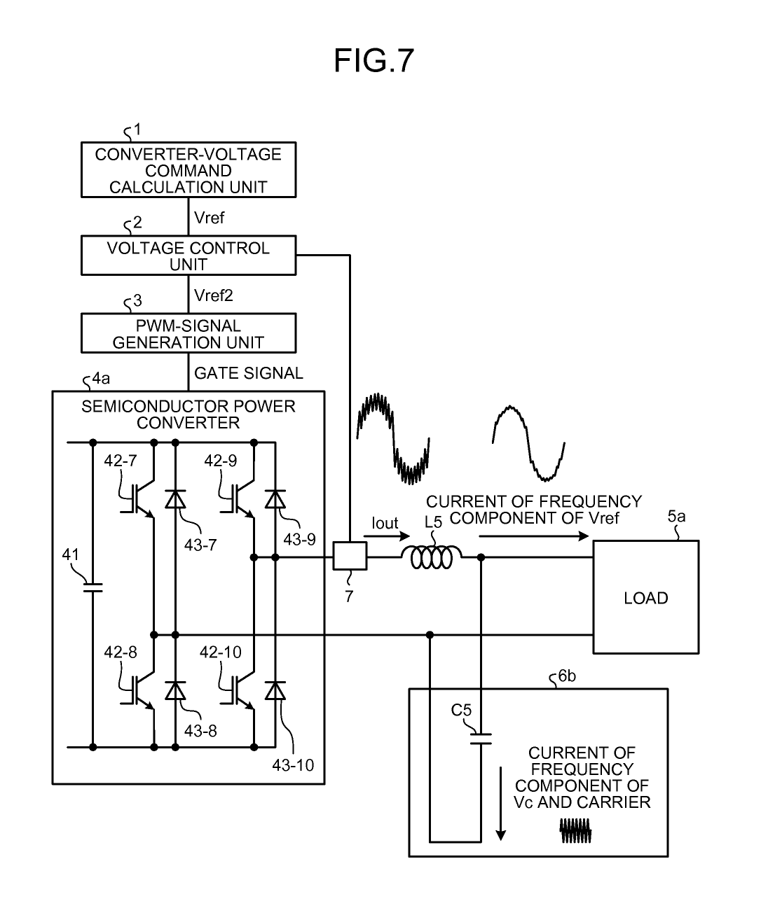

FIG. 7 is a diagram illustrating how the output current Iout output from the semiconductor power conversion apparatus is, and how a current flowing to a load and a bypass unit is in the present embodiment. Similarly to FIG. 6 illustrated in the first embodiment, to simplify the explanation, simulated are that the semiconductor power converter 4a is a single-phase converter, and the load 5a and the bypass unit 6a are of singes-phased. In the case of a three-phase converter, the relation of a current flowing to respective phases is identical to that of FIG. 7.

In FIG. 7, the output current Iout output from the semiconductor power converter 4a corresponds to the voltage command value Vref2 in which the superimposition component Vc is superimposed on the original voltage command value Vref; and a waveform of the harmonic superimposition frequency fc of the superimposition component Vc is superimposed on a sine-wave form of the voltage command value Vref. The LC resonant circuit having a resonant frequency fc2 is formed with an inductance component (an inductor L5) connected between the semiconductor power converter 4a and the load 5a along with a capacitor C5 of a bypass unit 6b.

Here, the bypass unit 6b branches the current of the harmonic superimposition frequency fc that is the frequency component of the superimposition component Vc and the current of the frequency component of the carrier frequency caused by switching of the switching elements 42-7 to 42-10 of the semiconductor power converter 4a off from the output current Iout output from the semiconductor power converter 4a. As a result, as illustrated in FIG. 7, a current, corresponding to the original voltage command value Vref which is the one before the voltage command value Vref2 is superimposed with the superimposition component Vc, slightly remained of the harmonic component thereon is to flow into the load 5a. In this case, some kind of the load cannot be applied depending to the characteristics of the loads. For example, in a case where the load 5a is a motor or the like, the high frequency component is basically hard to flow, so that problems hardly occur in actual uses.

In the case of the configuration illustrated in FIG. 7, because a current with the frequency component higher than the resonant frequency fc2 flows into the bypass unit 6b, the voltage control unit 2 superimposes the superimposition component Vc of the superimposition frequency corresponding to the frequency components of from the resonant frequency fc2 to the carrier frequency.

As explained above, according to the present embodiment, in a case where an inductance component is connected in advance between the semiconductor power converter 4 (or 4a) and the load 5 (or 5a), adding a capacitor as the bypass unit 6b makes up the LC resonant circuit along with the inductance component connected in advance. With this adding, the originally provided configuration can be used so that the number of components to add can be reduced.

### Third Embodiment

In the first embodiment, explained is a method of controlling the superimposing amount of the superimposition component Vc by feedback control in the voltage control unit 2. However, the superimposed amount of the superimposition component Vc can also be controlled by feedforward control.

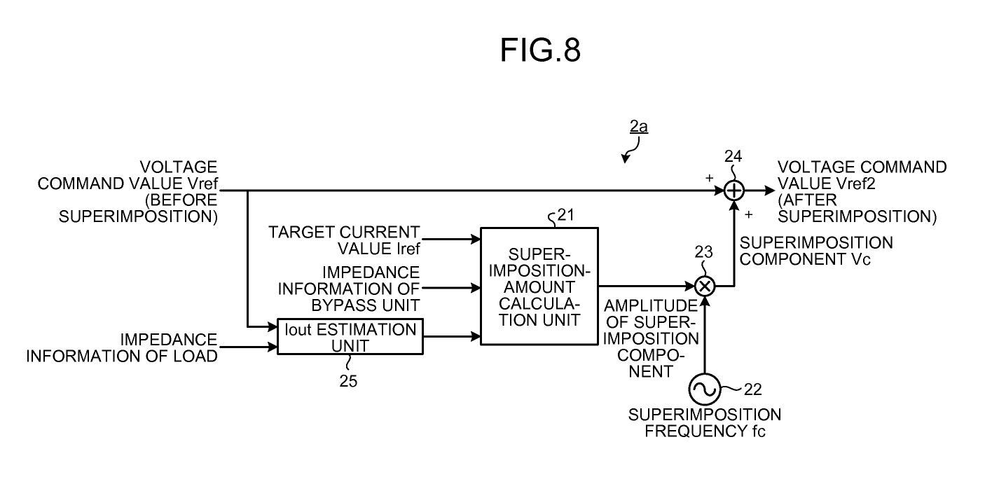

FIG. 8 is a diagram illustrating a configuration example of a voltage control unit according to the present embodiment. A voltage control unit 2a includes the superimposition-amount calculation unit 21, the superimposition-frequency signal transmitter 22, the multiplier 23, the adder 24, and an Iout estimation unit 25. The Iout estimation unit 25 inputs the voltage command value Vref and impedance information of the load 5 to estimate the output current value Iout from the semiconductor power converter 4 by using the voltage command value Vref and the impedance information of the load 5. A user or the like acquires the impedance information of the load 5 in advance by measurement or the like, and inputs the impedance information to the Iout estimation unit 25. The Iout estimation unit 25 is able to estimate the output current value Iout by dividing the voltage command value Vref by the impedance information of the load 5. The Iout estimation unit 25 outputs the estimated output current value Iout to the superimposition-amount calculation unit 21. Operations after the superimposition-amount calculation unit 21 inputs the value of the output current value Iout estimated by the Iout estimation unit 25 are identical to those of the first embodiment (see FIG. 3).

As explained above, according to the present embodiment, the voltage control unit 2a uses, instead of the output current Iout, the value of the estimated output current Iout based on the current command value Vref and the impedance information of the load 5. Accordingly, the superimposed amount on the voltage command value Vref can be controlled by feedforward control.

### INDUSTRIAL APPLICABILITY

As described above, the semiconductor power conversion apparatus according to the present invention is useful for power conversion using semiconductor components, and is particularly suitable for preventing semiconductor components from degraded.

### REFERENCE SIGNS LIST

1 converter-voltage command calculation unit, 2, 2a voltage control unit, 3 PWM-signal generation unit, 4, 4a semiconductor power converter, 5, 5a load, 6, 6a, 6b bypass unit, 7 current detection unit, 21 superimposition-amount calculation unit, 22 superimposition-frequency signal transmitter, 23 multiplier, 24 adder, 25 Iout estimation unit, 41 capacitor, 42-1 to 42-10 switching element, 43-1 to 43-10 diode.

1. A semiconductor power conversion apparatus comprising:
a power converter that performs power conversion by using a switching element and supplies power to a load;
a converter-voltage command calculation unit that outputs a first voltage command value that controls the power converter;
a voltage control unit that superimposes a second voltage command value on the first voltage command value to generate a third voltage command value;
a PWM-signal generation unit that generates a gate signal for controlling driving of the switching element based on the third voltage command value and outputs the gate signal to the power converter; and
a bypass unit that is connected to the power converter in parallel with the load and branches a current with a frequency of the second voltage command value off from an output current that is output from the power converter to the load.

2. The semiconductor power conversion apparatus according to claim 1, wherein
the voltage control unit obtains the second voltage command value based on a difference between an output current value from the power converter and a target current value that is a target value of the output current value.

3. The semiconductor power conversion apparatus according to claim 1, wherein
the voltage control unit
estimates an output current value from the power converter by using the first voltage command value and impedance information of the load, and
obtains the second voltage command value based on a difference between a target current value that is a target value of the output current value and an estimated output current value.

4. The semiconductor power conversion apparatus according to claim 1, wherein
the bypass unit is an LC resonant circuit including an inductor and a capacitor, and
an LC resonant frequency of the LC resonant circuit is the frequency of the second voltage command value.

5. The semiconductor power conversion apparatus according to claim 1, wherein
in a case where an inductor is connected between the power converter and the load, the bypass unit is provided with a capacitor to constitute an LC resonant circuit by the inductor and the capacitor, and
an LC resonant frequency of the LC resonant circuit is the frequency of the second voltage command value.

6. The semiconductor power conversion apparatus according to claim 1, wherein
the frequency of the second voltage command value falls in a frequency band that is larger than an operating frequency band of the power converter and is smaller than a carrier frequency band caused by switching of the switching element.

7. The semiconductor power conversion apparatus according to claim 1, wherein
the switching element is of a wide band-gap semiconductor.

8. A semiconductor power conversion apparatus comprising:
a power converter that performs power conversion by using a switching element and supplies power to a load;
a converter-voltage command calculation unit that outputs a first voltage command value that controls the power converter;
a voltage control unit that superimposes a second voltage command value on the first voltage command value to generate a third voltage command value; and
a PWM-signal generation unit that
generates a gate signal for controlling driving of the switching element based on the third voltage command value and
outputs the gate signal to the power converter, wherein
a current corresponding to the second voltage command value is branched off from output currents, which are output from the power converter to the load, by a bypass unit that is connected to the power converter in parallel with the load.

9. The semiconductor power conversion apparatus according to claim 8, wherein
the voltage control unit obtains the second voltage command value based on a difference between an output current value from the power converter and a target current value that is a target value of the output current value.

10. The semiconductor power conversion apparatus according to claim 8, wherein
the voltage control unit
estimates an output current value from the power converter by using the first voltage command value and impedance information of the load, and
obtains the second voltage command value based on a difference between a target current value that is a target value of the output current value and an estimated output current value.

11. The semiconductor power conversion apparatus according to claim 8, wherein
the frequency of the second voltage command value falls in a frequency band that is larger than an operating frequency band of the power converter and is smaller than a carrier frequency band caused by switching of the switching element.

12. The semiconductor power conversion apparatus according to claim 8, wherein
the switching element is of a wide band-gap semiconductor.

13. A semiconductor power conversion apparatus comprising:
a gate-signal generation unit that generates and outputs a gate signal for controlling a switching element;
a switching element that operates according to the input gate signal; and
a power converter that outputs an AC current having
a frequency component within a first frequency band in which a load is operated and
a frequency component in a second frequency band, which is different from the first frequency band and is branched off by a bypass unit that is connected in parallel to the load, wherein
when the frequency component in the first frequency band decreases, the frequency component in the second frequency band is increased, and
when the frequency component in the first frequency band increases, the frequency component in the second frequency band is decreased.

14. The semiconductor power conversion apparatus according to claim 13, wherein
the switching element is of a wide band-gap semiconductor.

15.-19. (canceled)
